(19) United States
(12) Patent Application Publication
(10) Pub. No.: US 2009/0050043 A1
(43) Pub. Date: Feb. 26, 2009

(54) DRAIN PLUG AND PORT ASSEMBLY

(76) Inventor: Alfredo Alvarez, Rancho Cordova, CA (US)

Correspondence Address: JOHN P. O'BANION;O'BANION & RITCHEY LLP, 400 CAPITOL MALL SUITE 1550, SACRAMENTO, CA, 95814, US

(21) Appl. No.: 12/195,294

(22) Filed: Aug. 20, 2008

Related U.S. Application Data
(60) Provisional application No. 60/956,777, filed on Aug. 20, 2007.

(51) Int. Cl. B63B 13/00; F16K 31/44

(52) U.S. Cl. 114/197; 251/216; 114/183 R

(57) ABSTRACT

A drain plug apparatus for draining a container that is particularly suited for transom drains in recreational boats is shown. The apparatus has a threaded drain plug that couples with a flanged tubular drain port with upper and lower sets of threads separated by a section without threads and at least one drain hole, in one embodiment. The distal end of the drain port has a number of slits that secure and orient the drain plug at the opening of the port in an open or closed position.

### CROSS-REFERENCE TO RELATED APPLICATIONS

This application claims priority from U.S. provisional application Ser. No. 60/956,777 filed on Aug. 20, 2007, incorporated by reference in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

1. Field of the Invention

This invention pertains generally to fluid relief valves, and more particularly to a drain plug assembly that has a threaded drain plug that is configured to mate with a tubular port that has a flared and slotted end that prohibits the accidental removal of the plug from the port of the assembly during use, while permitting full separation of the plug from the assembly when necessary.

2. Description of Related Art

Numerous valves and plugs have been devised to control the flow of fluid to and from the interior of containers and vessels. Such valved or plugged openings are often designed to allow collected fluid to drain from the container. For example, many types of marine vessels use a bore through the transom to permit the flow of accumulated bilge water out of the interior or engine well of the vessel when the vessel is removed from the water. The bore is normally positioned at a low point on the transom of the hull to facilitate the drainage of fluid out of the hull by forces of gravity. In the case of recreational boats, the boat typically is removed from the water on a trailer and then the plug is removed from the trans-hull bore when the boat is at an incline on the boat launch ramp. Water is thereby allowed to drain from the hull prior to transportation or storage of the boat.

Removal of water from the hull of a marine vessel is important in order to avoid damage to the mechanical and electrical components of the vessel as well as the hull during transportation or storage. For example, water left in the hull of the vessel can result in structural damage if allowed to freeze during storage and may also be the source of rot, corrosion, mold, mildew and unwanted odors. In addition, water may accumulate in the hull from rain or melting snow during storage. The level of existing water in the hull may be increased from these additional water sources and can infiltrate the fuel, mechanical and electrical systems of the vessel causing damage to these systems. High interior water levels may also cause damage to the contents of vessel. Consequently, recreational boats are routinely transported and stored with the plug removed from the transom drainage bore of the vessel.

Many types of transom drain plugs are known in the art. Some plugs are made of rubber and may include a means for compressing the plug to increase the frictional force exerted by the plug in the transom drainage bore and reduce the chance of unintentional removal of the plug during use of the vessel. Other common plugs include threaded metal plugs that are advanced upon corresponding threads in a flange or collar disposed in the transom bore.

Conventional drainage plugs must be manually inserted into the transom bore prior to launching the vessel into the water. If the vessel is launched without the proper placement of the plug, water can enter the engine compartment and hull of the vessel through the drainage bore which creates a risk of sinking or internal damage to the vessel if the failure to place the plug is not discovered. Replacement of the plug while the vessel is in the water can often be difficult because of the placement of the bore far below the waterline and the difficulties encountered while attempting to thread the plug in the bore under water.

Operation of the vessel that has a drainage bore is not possible without the proper placement of the plug. As an independent component, the plug can be misplaced or lost after removal. Storage of the plug in a secure place may not provide easy access to the plug if the vessel is launched without the plug in place.

Accordingly, in order to avoid the risk of sinking or damage to a vessel after launch, there is a need to have a drain that can be conveniently opened and closed without the need to independently store the plug during transportation and storage of the vessel. The present invention satisfies this need, as well as others, and generally overcomes the limitations of the prior art.

### BRIEF SUMMARY OF THE INVENTION

The present invention is a container plug that allows the user to regulate the flow of contents to or from a container when open and to seal the contents of the container when the drain is closed.

By way of example, and not of limitation, one embodiment of the invention is adapted for use as a drain plug for a boat. Although a boat plug is used for illustration, it will be understood that the assembly can be adapted for use on any type of container to permit the flow of liquids, gasses or other fluids from the container.

One drawback of prior boat plugs, for example, is that the user often forgets to insert the transom plug or looses the plug during drainage or transportation of the boat. The apparatus of the present invention provides a plug and port assembly that will not allow the plug to be inadvertently removed from the drainage bore or lost during drainage or transportation of the boat or container. One embodiment of the present invention will also allow the quick and easy insertion of the plug under the waterline or closure of the drain if the boat owner forgets to plug the transom drain after launching the boat.

The drain plug assembly of the invention has two associated members: a plug and a drain port. The drain port includes a tubular drain body with a central channel and transverse bores. The drain port transects the wall of the container and is securely mounted to the container wall. The drain port body can vary in size to permit the release of differing volumes of fluids from the container over time through the central channel and bores of the port.

The central bore of the tubular drain body has two sets of inner threads preferably separated by an unthreaded section that has one or more transverse bores that open the central channel and permit the flow of fluid out of the body of the drain port.

The tubular drain port body also includes a plurality of longitudinal slits on one end of the body that permits the circumferential expansion of the resulting sections of the distal end of the drain port body during insertion of the plug into the top set of threads in the opening of the drain port of the container. The opposite end of the drain port body preferably has a mounting flange to secure the drain port to the inside surface or outside surface of the container. The mounting flange can be secured to the wall of the container by fasteners such as screws, bolts or adhesives.

The first set of threads on the interior of the drain port body is on the end with the mounting flange. In one embodiment, the interior channel with the first set of threads is slightly tapered in the direction of the end of the body with the mounting flange. The second set of threads is placed on the end of the body farthest from the mounting flange and these threads are sectioned by the lengthwise slits.

The drain plug is generally cylindrical with a threaded tip section on one end and a handle on the other end. The diameter of the threaded tip is preferably slightly larger than the diameter of the interior threads of the second set of threads. The slots allow the distal end to expand radially and circumferentially when the threaded tip of plug is advanced through the second set of threads toward the interior of the body of the port and then to return to the original position. The threaded tip of the plug then engages the first set of threads on the interior of the tube that seals the channel closed when the tip is fully tightened within the threads of the drain port. In one embodiment, the threaded tip is slightly tapered so that it provides a fluid tight fit to seal the drain port.

Accordingly, fluid may be drained by unscrewing the plug handle until it separates from the first set of threads and back to expose the transverse bores in the sidewalls of the drain port body. The threads from the tip of the plug can then engage the second set of threads. Rotation of the body will become substantially difficult to indicate to the user to stop unscrewing the drain plug. The plug should be secured by the pressure exerted by the slightly flared section of threads of the port on to the back threads of the threaded tip of the plug. The threads of the flared end of the drain port body keep the plug firmly in the drain opening when the plug is in the open position and therefore the plug will not be inadvertently removed when the drain is initially opened or during the draining of the container. In addition, the drain port can be opened or closed without the need to orient, insert and rotate the drain plug within a flow of fluid exiting the container since the plug is always oriented within the drain opening of the container.

It can be seen that the drain plug need not be removed from the port after installation since the fluid drains through the central channel and out of the transverse bores that are preferably exposed without removing the plug from the second set of threads. In addition, even though it is unnecessary to completely remove the drain plug to open the drain, it will be seen that the plug can be completely removed from the container by forceful rotation of the plug expanding the second set of threads in the slotted end of the drain port body. The plug can then be transferred to another container if desired or replaced in the drain port of the container at a later time.

In the case of a boat, the drain plug can be easily opened and closed even in the water because the plug is oriented over the drain port. Upon removal of the boat from the water, the handle of the plug is rotated to open the drain plug to drain bilge water, typically when the boat is resting on a trailer that is on the boat-launching ramp.

When the drain plug is removed from the first set of threads, bilge water can drain through central channel of the port and out of bores. It can be seen that the drain plug will not inadvertently fall out of the port when draining or transporting the container because of the engagement of the plug with the threads of the port. The flow of water from the bilge can also be easily stopped and started before the entire contents of the bilge are eliminated. The boat may also be transported with the drain in the open position because the slotted section of the port will keep the plug secure during transportation. The drain plug can also be conveniently stored in the transom opening and will not be lost during storage.

According to one aspect of the invention, a drain plug assembly is provided that has a drain port with a tubular body with an interior threaded, expandable end that is configured to radially expand when a drain plug is initially advanced into the threaded drain port of a container.

According to another aspect of the invention, a drain plug assembly is provided that secures that plug in an open position in a proximity and orientation so that the plug can be quickly and easily placed in a closed position.

A further aspect of the invention provides a drain plug apparatus for a marine vessel having a drain plug and a threaded tubular port that has a cylindrical body with a central channel and a plurality of transverse bores fluidly connected to the central channel and a mounting flange. The cylindrical body of the port also has a plurality of internal threads and lengthwise slits at one end configured to expand if a plug with a larger bore that the channel is advanced through the threads, and a plug with a cylindrical body with a threaded tip that is sized to be greater than or equal to the diameter of the threaded tubular port.

A still further aspect of the invention is to provide a durable drain plug assembly that can be variable in size and material composition that is easy to manufacture and use.

Yet another aspect of the invention is to provide a means for regulating the volume of the flow of liquid from a container.

Accordingly, another aspect of the invention is an in-hull drain apparatus. In one embodiment, the apparatus includes (a) a drain port with a flange configured to fit into a drain hole recess on a boat's hull, where the port has upper and lower threaded stages, and a sidewall between the upper and lower threaded stages, and where the port has at least one drain hole located in the sidewall between the upper and lower threaded stages; and (b) an elongated drain plug configured for insertion into an opening between the upper and lower threaded stages, where the drain plug has means for securing or loosening the drain plug, such as a handle and/or through-handle holes allowing the insertion of a screwdriver or other device through the holes for additional leverage; (c) wherein, when the drain plug is positioned in the port, water transfer through the drain holes located in the sidewall between the upper and lower threaded stages can be controlled by moving the drain plug between a first closed position and a second open position.

Further aspects of the invention will be brought out in the following portions of the specification, wherein the detailed description is for the purpose of fully disclosing preferred embodiments of the invention without placing limitations thereon.

### BRIEF DESCRIPTION OF THE SEVERAL VIEWS OF THE DRAWINGS

The invention will be more fully understood by reference to the following drawings which are for illustrative purposes only:

FIG. 1 is a perspective depiction of one embodiment of a drain plug assembly with the plug and port components separated according to the present invention.

FIG. 2 is a side view of the drain port component of the drain plug assembly embodiment shown in FIG. 1.

FIG. 3 is a side cross sectional view of the drain port component shown in FIG. 2 taken along the lines 3-3 of FIG. 2.

FIG. 4 is a side view of a drain plug component of the embodiment of the drain plug shown in FIG. 1 according to the present invention.

FIG. 5 is a side view of one embodiment of a plug and drain port assembly in the “closed” position with the plug and port components coupled together according to the present invention.

FIG. 6 is a side view of one embodiment of a plug and drain port assembly in the “open” position with the plug and port components coupled together according to the present invention.

### DETAILED DESCRIPTION OF THE INVENTION

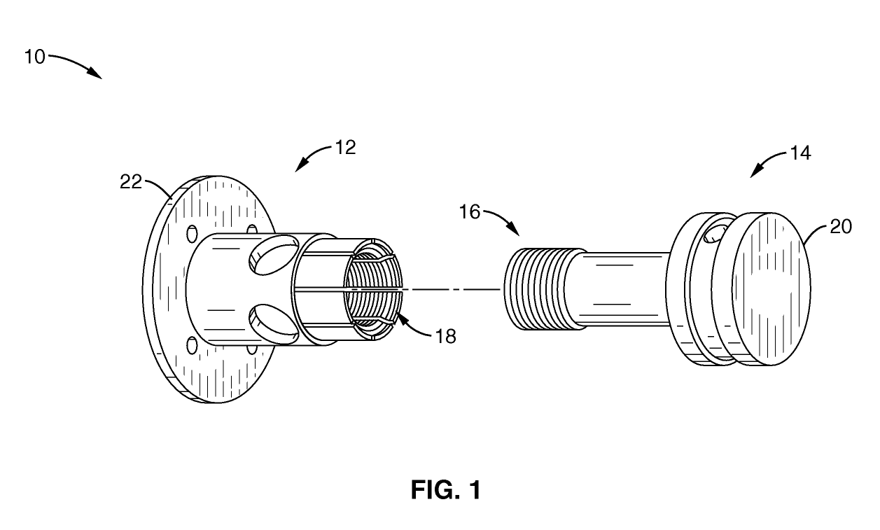

Referring more specifically to the drawings, for illustrative purposes the present invention is embodied in the apparatus generally shown in FIG. 1 through FIG. 6. It will be appreciated that the apparatus may vary as to configuration and as to details of the parts without departing from the basic concepts as disclosed herein. The present invention pertains to a container plug and port assembly that can be used to drain and seal the container and the drain plug will not be inadvertently removed during use. The drain plug assembly 10 of the present invention may be sized to fit many different containers such as those commonly used with a transom of a conventional boat. Although a transom drain of a typical powerboat is used as an illustration of a type of container and is not meant to be limiting.

Referring first to FIG. 1, one embodiment of the drain plug assembly 10 according to the invention with the drain port 12 disengaged from the drain plug 14 is shown. The drain plug 14 is generally cylindrical body and has a threaded tip 16 and a handle 20. The threads of the threaded tip 16 initially engage corresponding threads 18 in the interior of the tubular drain port 12.

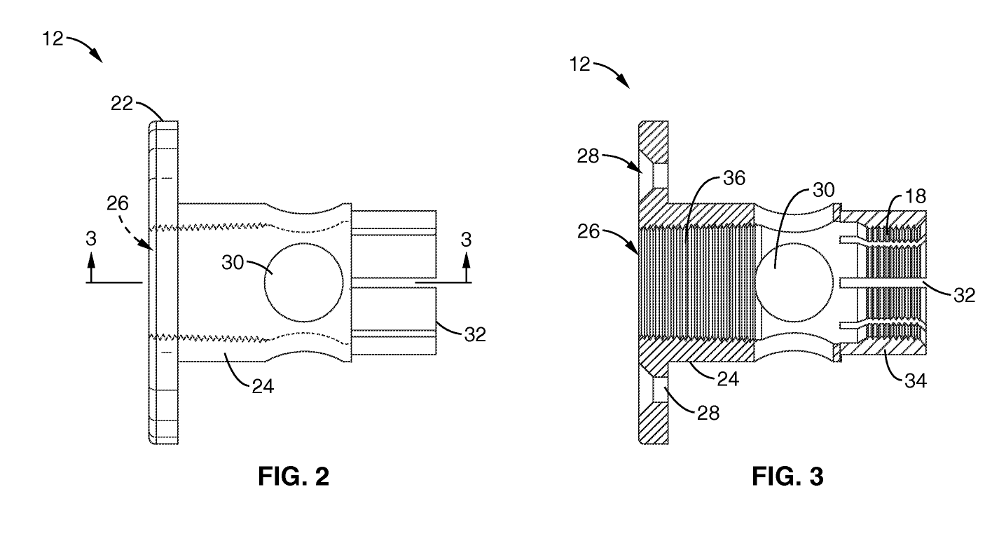

Referring also to FIG. 2 and FIG. 3, the preferred drain port 12 comprises a generally cylindrical body 24 with a longitudinal central channel 26 through the length of the body 12. The drain body 12 has a circumferential flange 22 at the proximal end of the body 24 that is used to anchor the drain port 12 to the wall of a container. The embodiment shown in FIG. 2 and FIG. 3 has countersunk screw holes 28 to permit the cylindrical body 24 of port 12 to be disposed through a bore in the container wall and the flange to be mounted to the inside wall of the container with screws.

The body 24 of the drain port 12 also includes a plurality of radial bores 30 through the sidewall of the cylindrical body 24, which open the central channel 26 to the exterior of the body 24. Although two pairs of transverse bores are shown in the embodiment shown in FIG. 1, it will be understood that any number of bores can be used and positioned in the sidewalls of cylindrical body 24. In one embodiment, a single bore 30 is used to permit the directional flow of fluid from the container through channel 26 of cylindrical body 24 of drain port 12.

Not only can the number of bores 30 in the body 24 vary, the diameter of the bores 16 can be varied as well to regulate the rate of flow of fluid through the body 12 of drain port 24. The length of the cylindrical body 24 can also vary to achieve desired drainage rates. Different sized bores 30 may also be placed at different positions along the length of the body 24 to regulate and change the rate of drainage from the container depending on the position of the plug 14 in channel 26, in an alternative embodiment.

The distal end of cylindrical body 24 also has a plurality of notches or slits 32 in the end that begin at the end of the opening of the central channel 26 and extending longitudinally along a portion of the length of the port cylindrical body 24. It can be seen that the slots 32 will allow the distal end of the body 24 to radially expand slightly during installation of plug 14 and subsequent use. One or more slits 30 can be used to allow varying amounts of radial compression on drain the plug 14.

As seen in FIG. 1 and FIG. 3, the interior surface of cylindrical body 24 is threaded with one or more sets of threads. In the embodiment shown, there are two sets of interior threads separated by a center section without threads. The first set of threads 18 are at the distal end of body 24 and are transected by the linear slits 32. As a consequence, the first set of threads can accommodate a corresponding set of threads 16 on the tip of the drain plug 14 that are slightly larger than the diameter of the channel 26 because the section can expand circumferentially due to the slits 32. Pressure is exerted on the threads 16 of the drain plug 14 by each expanded section 34 of the distal end of the cylindrical body 24. It will be seen that once the threads 16 of the tip section of the plug 14 are advanced through the first set of threads 18, the distal sections 34 will contract radially back to the original position and the torque necessary for axial rotation of the drain plug 14 will be greatly reduced.

The second set of threads 36 in the interior of cylindrical body 24 is located at the proximal end of the body 24. In one embodiment, threads 36 have a slowly decreasing diameter so that threads 34 have a gradual taper that decreases from the center toward the proximal end of the channel 26 of body 24. The threads will provide an increasingly tighter fit within threaded opening 36 as the threads 16 of the plug 14 are advanced thereby providing a fluid-tight seal. There are many types of threads known in the art that can be used depending on the contents of the container and whether the contents are under pressure including NPT, NPTF, NPSM, BSPT, BSPP threads and the like. However, ½-NPT X 12 threads are preferred.

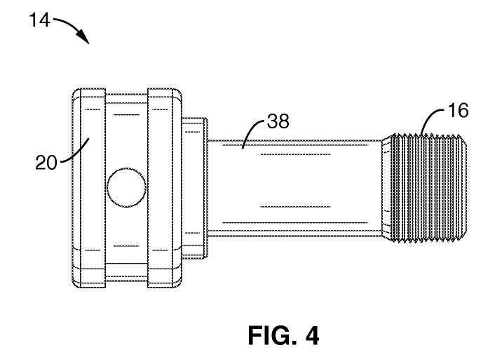

Turning now to FIG. 4, the drain plug 14 preferably has a handle 20 that will facilitate the rotation of the handle 20 and plug shaft 38 and threaded tip 16. The handle 20 can be disc shaped to fit the hand and to increase leverage on the handle and the applied torque. The handle 20 permits the orientation and axial rotation of the drain plug 14 with the drain port 12 of the assembly 10.

In the embodiment shown in FIG. 4, a receptacle 40 in the handle 20 is provided accommodate a rod (not shown) or screwdriver shaft to increase the forces applied to the handle 20 and the ease of use of the rotation of the handle 20. Handle 20 may also have a shaped end that is configured to engage a standard wrench or may include a socket or other tooling system that will assist with the rotation of the plug body 14 during use.

The shaft 38 of the drain plug 14 may have a smaller diameter than the threaded tip 16. The shaft 38 of the plug is preferably solid metal. However, in one embodiment, the shaft 38 is tubular.

In use, the two components 12,14 of the drain plug assembly 10 are separated and the drain port 12 is placed and mounted in a properly sized hole in the wall of a container. The flange 22 can be mounted with any suitable set of fasteners. The flange 22 may also secure a seal or sealant to eliminate leaking around the port if necessary depending on the type of fluids or type of container.

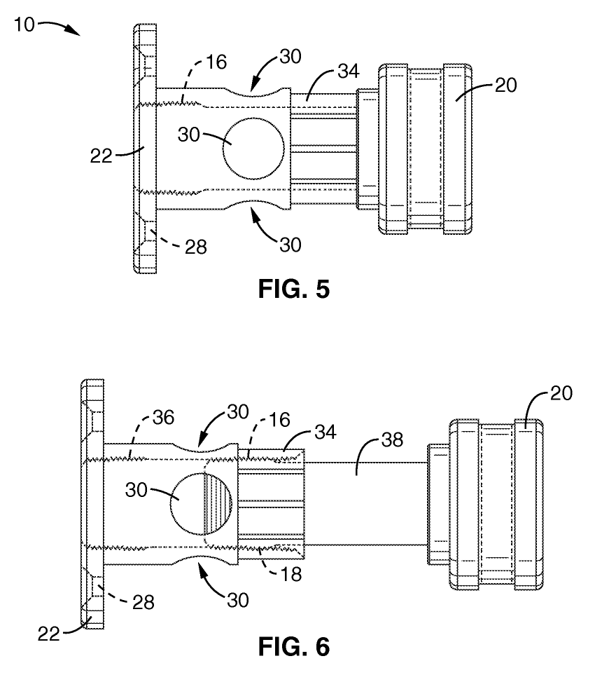

Referring also to FIG. 5 and FIG. 6, the threads of threaded tip section 16 of the drain plug 14 engage and are advanced through the first set of threads 18 of the distal opening of the drain port 12 that is mounted to the container or boat.

The distal end of the tubular body 24 of port 12 radially expands facilitated by slits 32 when the threaded tip 16 of the plug 14 advances through the threads 18 of the drain port 12. Once the threads 16 of the tip of the drain plug have advanced through the first set of threads 18 of the drain port, the distal end body 24 contracts and returns to the original resting position. The threads 18 of the port only surround the shaft 38 and the assembly is in the “open” position. It can be seen that fluid from the interior of the container can travel through the channel 26 and out of the bore holes 30 to the exterior.

The drain plug 14 can slide lengthwise within the center portion of the drain port 12 in the embodiment shown in FIG. 3 until the threaded tip 16 engages the second set of threads 36 of the port 12. If the plug body 14 continues to be advanced, the threads 16 of the plug will fully engage the second set of threads 36 of the port 12 and provide a water-tight seal. The plug is now in the fully “closed” position and water is incapable of entering or being eliminated through the transom, for example, as shown in FIG. 5. In one embodiment, the tip threads 16 of the plug and the second set of threads 36 of the body 24 have the same corresponding taper and provide a strong seal.

In the boat adaptation, the drain plug 14 may be opened when the boat is withdrawn from the water to permit the removal of bilge water. As seen in FIG. 6, the drain plug 14 is rotated axially until the threads 16 of the tip section of the plug disengage the second set threads 36 of the opening of the drain port 12 allowing the flow of fluid through channel 26. The plug can continue to slide away from the container until the back threads of the plug tip 16 encounter the first set of threads 18. Continued rotation of the plug 14 will increase the pressure on the plug threads 16 from expansion of the slotted port sections 34 securing the drain plug 14 in an “open” position while the container is drained.

The drain plug 14 need not be completely removed from the drain port 12 to drain the container and the plug body can be placed securely within the first set of threads 18 of the port 12 during draining. Therefore, it can be seen that the plug 14 will not be lost during draining or misplaced after installation because the plug 14 is never removed from the opening and is firmly engaged with the first set of threads 18 in the opening during use. In addition, the container can be transported with the drain assembly in the “open” position because the plug 14 is firmly secured.

The plug of the invention is preferably made from materials such as brass that do not readily corrode or oxidize or react with the fluids and may additionally have coatings to avoid corrosive interactions with liquids or gases. Special materials may also be selected based on the expected temperature range to be experienced by the fluids or the container.

Although the description above contains many details, these should not be construed as limiting the scope of the invention but as merely providing illustrations of some of the presently preferred embodiments of this invention. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.”

What is claimed is:

1. A drain plug apparatus, comprising:
a tubular body having a central channel with at least one sidewall orifice, an expandable end with a plurality of longitudinal slits and internal threads; and
a threaded drain plug sized to mate with the internal threads of said tubular body;
wherein said expandable end of said tubular body is configured to radially expand when said threaded drain plug is inserted in said channel of said tubular drain port.

2. An apparatus as recited in claim 1, wherein said tubular body further comprises a mounting flange.

3. An apparatus as recited in claim 1, wherein said internal threads of said tubular body further comprises:
a first set of internal threads; and
a second set of internal threads;
wherein said first set of internal threads and said second set of internal threads are separated by an internal section without threads.

4. An apparatus as recited in claim 3, wherein said first set of internal threads of said threaded tubular body have tapered threads and said second set of internal threads are straight threads.

5. An apparatus as recited in claim 1, wherein said threaded drain plug further comprises a tapered top.

6. An apparatus as recited in claim 1, wherein said threaded drain plug further comprises a handle.

7. An apparatus as recited in claim 6, wherein said threaded drain plug further comprises a lever coupled to said handle.

8. An apparatus as recited in claim 1, wherein a diameter of said threads of said threaded drain plug is greater than the diameter of an opening of said expandable end of said tubular body.

9. A drain plug apparatus, comprising:
a drain plug having a handle, shaft and threaded top; and
a tubular body having a central channel with at least one sidewall orifice, an expandable end with a plurality of longitudinal slits, a first set of internal threads and said second set of internal threads separated by a section without threads;
wherein said expandable end of said tubular body is configured to radially expand when said threaded tip of said drain plug is advanced through said first set of internal threads.

10. An apparatus as recited in claim 9, wherein said tubular body further comprises a mounting flange.

11. An apparatus as recited in claim 9, wherein said tubular body further comprises a central channel that varies in cross-sectional diameter along the length of said tubular body.

12. An apparatus as recited in claim 9, wherein said threaded drain plug further comprises a lever coupled to said handle.

13. An apparatus as recited in claim 9, wherein said shaft of said threaded drain plug has a cross-sectional diameter that is less than the cross-sectional diameter of said central channel of said tubular body.

14. An apparatus as recited in claim 9, wherein said section of said shaft of said threaded drain plug has a cross-sectional diameter that is less than the cross-sectional diameter of said central channel of said tubular body.

15. An apparatus as recited in claim 9, wherein said first set of internal threads of said threaded tubular body are straight threads and said second set of internal threads are tapered threads.

16. An apparatus as recited in claim 9, wherein said section of said channel without threads has a cross-sectional diameter that greater than the cross section of said drain plug, wherein said drain plug can slide longitudinally when the threaded top is advanced through said first set of threads.

17. An in-hull drain apparatus, comprising:
a flanged port configured to fit into a drain hole recess on a boat's hull;
said flanged port having upper and lower threaded stages, and a sidewall between the upper and lower threaded stages;
said flanged port having at least one drain hole located in the sidewall between the upper and lower threaded stages; and
an elongated drain plug;
said drain plug having means for tightening and loosening the drain plug in said flanged port;
said drain plug configured for insertion into an opening in said flanged port between said upper and lower threaded stages;
wherein, the drain plug is positioned in the flanged port, fluid transfer through the drain holes located in the sidewall between the upper and lower threaded stages can be controlled by moving the drain plug between a first closed position and a second open position.

18. An apparatus as recited in claim 17, wherein said lower threaded stage of said flanged port and said drain plug have matched tapered threads.

19. An apparatus as recited in claim 17, wherein said means for tightening and loosening said drain plug comprises a lever coupled to a handle.

20. An apparatus as recited in claim 17, wherein said drain plug can be secured in the open position by engagement with said upper threaded stage of said flanged port.
